(19) United States
(12) Patent Application Publication
(10) Pub. No.: US 2025/0293530 A1
(43) Pub. Date: Sep. 18, 2025

(54) BATTERY EQUALIZER AND METHOD OF CONDUCTING A BATTERY EQUALIZATION

(71) Applicant: City University of Hong Kong, Hong Kong (CN)

(72) Inventors: Shu Hung Henry CHUNG, Hong Kong (CN); Zhengqi WEI, Hong Kong (CN)

(21) Appl. No.: 19/016,162

(22) Filed: Jan. 10, 2025

Related U.S. Application Data
(60) Provisional application No. 63/564,649, filed on Mar. 13, 2024.

(51) Int. Cl. H02J 7/00

(52) U.S. Cl. CPC H02J 7/0014; H02J 2207/20; H02J 2207/50

(57) ABSTRACT

A battery equalizer for a series-connected battery string. The battery equalizer contains a plurality of cell circuits, an AC link, and a DC/AC converter. The plurality of cell circuits at their input ends is connected in parallel with each other and to the AC link. Each cell circuit at its output end is adapted to connect to a corresponding battery cell of the battery string. The DC/AC converter connects to the AC link. Each of the cell circuits contains an AC/DC converter, and an AC side of the AC/DC converter is capacitively-coupled to the AC link at the input end of the cell circuit. As the current taken from the first stage is common to all battery cells, charging or discharging of individual battery cells is autonomously determined by the output current of the second stage.

### RELATED APPLICATIONS

This application claims priority to U.S. Provisional Application No. 63/564,649 filed 13 Mar. 2024, the entirety of which is incorporated herein.

### FIELD OF INVENTION

This invention relates to battery management systems, and in particular to equalization of battery cells in a battery system.

### BACKGROUND OF INVENTION

With the growing prevalence of the electric vehicles (EVs), it is foreseeable that a significant number of batteries from retired EVs will accumulate globally [1]. Carbon footprint of a lithium-ion EV battery can be reduced by up to 17% if it is reused before being recycled [2]. These batteries still possess usable capacity and can be repurposed for stationary energy storage systems [3]. As shown in FIG. 1, solar and wind energy can be stored in large-scale energy systems that can power the grid and charge electric vehicles. However, how to extend the life or retired batteries remains a major challenge. Prolonged use leads to inconsistent battery characteristics, reducing the available capacity and compromising the battery's lifespan [4]. Therefore, battery voltage balancing is vital for ensuring safe and efficient battery operation, which balances cell charging and discharging rates, extending the battery's lifespan, preventing damage or safety risks from overcharging or discharging, and maximizing the battery's energy storage capacity [5].

Battery equalization structures can be categorized into two main types: DC-DC converter with selective switches (DCSS) and multiport circuit (MC) [6]. The structure of DCSS is simple (as shown in FIG. 2a) as it leverages existing DC-DC converters and multiplexer, resulting in a straightforward implementation [7]. In [8], a bidirectional converter based equalizer is proposed, and high integration and reliability are achieved. In [9], a wide voltage range converter based equalizer is proposed. The equalizer achieves bidirectional energy flow across a wide voltage range while maintaining high energy conversion efficiency. However, DCSS typically necessitates a substantial number of switches to facilitate the selection of the desired battery cell to balance. This requirement imposes a demand for intricate control and driving circuits, particularly when equalizing a considerable quantity of batteries. In addition, the DCSS has only one output. When several batteries need to be equalized, the selector switches need to be switched to select the target battery, and only one battery can be equalized at any time [10].

Multiport circuits need to be designed to replace converter and selective switches network, as shown in FIG. 2b. No selection switch is needed as the charge can be transferred autonomously to the target cells, resulting in a reduction in the number of active components. Moreover, the MC allows for simultaneous equalizing of multiple batteries, thus greatly reducing the equalization time. In [11], a parallel-transformer-based integrated equalizer is proposed. This method utilizes a cascade multi-winding transformer, where the secondary side of the main transformer achieves balance within each module. This approach achieves both intra-module and inter-module balancing functions. In [12], a multi-layer voltage equalizer is proposed, which targets multiple cells at the same time, therefore its equalization speed is high. However, multi-winding transformer are commonly used in the MC [13], as shown in FIG. 2c. Typically, one winding is required for each battery in a transformer. If there are many cells, transformer design and implementation will become challenging.

### REFERENCES

Each of the following references (and associated appendices and/or supplements) is expressly incorporated herein by reference in its entirety:
[1] M. A. Hannan et al., “SOC Estimation of Li-ion Batteries With Learning Rate-Optimized Deep Fully Convolutional Network,” IEEE Trans. Power Electron., vol. 36, no. 7, pp. 7349-7353 July 2021, doi: 10.1109/TPEL.2020.3041876.
[2] M. Chen et al., “Recycling End-of-Life Electric Vehicle Lithium-Ion Batteries,” Joule, vol. 3, no. 11, pp. 2622-2646 November 2019, doi: 10.1016/j.joule.2019.09.014.
[3] H. Yin, Y. Li, Y. Kang, and C. Zhang, “A two-stage sorting method combining static and dynamic characteristics for retired lithium-ion battery echelon utilization,” J. Energy Storage, vol. 64, p. 107178, August 2023, doi: 10.1016/j.est.2023.107178.
[4] G. Noh, J. Lee, and J.-I. Ha, “Design and Analysis of Single-Inductor Power Converter for Both Battery Balancing and Voltage Regulation,” IEEE Trans. Ind. Electron., vol. 69, no. 3, pp. 2874-2884 March 2022, doi: 10.1109/TIE.2021.3065606.
[5] M. Uno, R. Sugaya, and Y. Sasama, “Selective Module-to-Cell Equalizer With Internal AC Heating Capability for Automotive Lithium-Ion Batteries at Subzero Temperatures,” IEEE J. Emerg. Sel. Top. Power Electron., vol. 11, no. 5, pp. 5430-5440 October 2023, doi: 10.1109/JESTPE.2023.3289447.
[6] Y. Izadi and R. Beiranvand, “A Comprehensive Review of Battery and Supercapacitor Cells Voltage-Equalizer Circuits,” IEEE Trans. Power Electron., vol. 38, no. 12, pp. 15671-15692, December 2023, doi: 10.1109/TPEL.2023.3310574.
[7] Z. Wei, H. Wang, Y. Lu, D. Shu, G. Ning, and M. Fu, “Bidirectional Constant Current String-to-Cell Battery Equalizer Based on L2C3 Resonant Topology,” IEEE Trans. Power Electron., vol. 38, no. 1, pp. 666-677, January 2023, doi: 10.1109/TPEL.2022.3205440.
[8] X. Qi, Y. Wang, and M. Fang, “An Integrated Cascade Structure-Based Isolated Bidirectional DC-DC Converter for Battery Charge Equalization,” IEEE Trans. Power Electron., vol. 35, no. 11, pp. 12003-12021, April 2020, doi: 10.1109/TPEL.2020.2988661.
[9] W. Lujun et al., “Efficient and Fast Active Equalization Method for Retired Battery Pack Using Wide Voltage Range Bidirectional Converter and DBSCAN Clustering Algorithm,” IEEE Trans. Power Electron., vol. 37, no. 11, pp. 13824-13833, November 2022, doi: 10.1109/TPEL.2022.3185242.
[10] S. K. Dam and V. John, “A Modular Fast Cell-to-Cell Battery Voltage Equalizer,” IEEE Trans. Power Electron., vol. 35, no. 9, pp. 9443-9461 September 2020, doi: 10.1109/TPEL.2020.2972004.
[11] K. Chen et al., “Double-Layer Multi-Winding Transformer-Based Modular Integrated Equalizer for Extended Battery String,” IEEE Trans. Power Electron., vol. 39, no. 2, pp. 2685-2695 September 2023, doi: 10.1109/TPEL.2023.3314931.
[12] H. Nazi and E. Babaei, “A Modularized Bidirectional Charge Equalizer for Series-Connected Cell Strings,” IEEE Trans. Ind. Electron., vol. 68, no. 8, pp. 6739-6749 August 2021, doi: 10.1109/tie.2020.3003661.
[13] M. Liu, Y. Chen, Y. Elasser, and M. Chen, “Dual Frequency Hierarchical Modular Multilayer Battery Balancer Architecture,” IEEE Trans. Power Electron., vol. 36, no. 3, pp. 3099-3110 March 2021, doi: 10.1109/tpel.2020.3015768.
[14] R. C. Viero and F. S. dos Reis, “Dynamic modeling of a ZETA converter in DCM applied to low power renewable sources,” in 2011 IEEE Energy Conversion Congress and Exposition, September 2011, pp 685-691. doi: 10.1109/ECCE.2011.6063836.
[15] Z. Wei, F. Peng, and H. Wang, “An LCC Based String-to-Cell Battery Equalizer with Simplified Constant Current Control,” IEEE Trans. Power Electron., vol. 37, no. 2, pp. 1816-1827, 2021, doi: 10.1109/TPEL.2021.3102627.
[15] M. Uno and K. Tanaka, “Single-Switch Cell Voltage Equalizer Using Multistacked Buck-Boost Converters Operating in Discontinuous Conduction Mode for Series-Connected Energy Storage Cells,” IEEE Trans. Veh. Technol., vol. 60, no. 8, pp. 3635-3645 October 2011, doi: 10.1109/TVT.2011.2165229.
[17] N. Hasanpour, M. R. Mohammadi, A. Tavakoli, and S. Ali Khajehoddin, “Modular Voltage Equalizer Circuit with AC-bus Inter-Modules Connection,” IEEE Trans. Transp. Electrification, pp. 1-1, 2023, doi: 10.1109/TTE.2023.3280063.
[18] X. Qi, Y. Wang, M. Fang, H. Wang, Y. Wang, and Z. Chen, “A Family of Integrated Cascade Multiport Converters for Centralized Equalization Systems: Derivation, Analysis, and Verification,” IEEE Trans. Power Electron., vol. 38, no. 6, pp. 7398-7415 June 2023, doi: 10.1109/TPEL.2023.3246723.
[19] Y. Shang, S. Zhao, Y. Fu, B. Han, P. Hu, and C. Mi, “A Lithium-Ion Battery Balancing Circuit Based on Synchronous Rectification,” IEEE Trans. Power Electron., vol. 35, no. 2, pp. 1637-1648, 2019, doi: 10.1109/tpel.2019.2917390.
[20] L. Liu, Z. Yan, B. Xu, P. Zhang, C. Cai, and H. Yang, “A Highly Scalable Integrated Voltage Equalizer Based on Parallel-Transformers for High-Voltage Energy Storage Systems,” IEEE Trans. Ind. Electron., vol. 71, no. 1, pp. 595-603, January 2024, doi: 10.1109/TIE.2023.3241382.

### SUMMARY OF INVENTION

The invention accordingly provides, in a first aspect, a battery equalizer for a series-connected battery string. The battery equalizer contains a plurality of cell circuits, an AC link, and a DC/AC converter. The plurality of cell circuits is connected in parallel with each other at their input ends. Each cell circuit at its output end is adapted to connect to a corresponding battery cell of the battery string. The plurality of cell circuits connects to the AC link at the input ends. The DC/AC converter connects to the AC link. Each of the cell circuits contains an AC/DC converter. An AC side of the AC/DC converter is capacitively-coupled to the AC link at the input end of the cell circuit.

In some embodiments, the DC/AC converter contains a voltage source, and an active switch which is connected between the voltage source and the AC link.

In some embodiments, the active switch is the only active switch of the battery equalizer.

In some embodiments, the DC/AC converter further contains a first inductor as a magnetizing inductance, which is connected in series to the active switch between two ends of the voltage source.

In some embodiments, the first inductor is the only magnetic component of the battery equalizer.

In some embodiments, the voltage source is a first capacitor adapted to be charged by the battery string.

In some embodiments, each cell circuit further contain two coupling capacitors at the input end. The AC/DC converter of the cell circuit is connected to the AC link through the two coupling capacitors.

In some embodiments, the AC/DC converter in each cell circuit contains, between two ends of the corresponding battery cell of the cell circuit, a second inductor and a diode which are connected in series.

In some embodiments, each cell circuit further comprises an output filter that is connected between the AC/DC converter and the corresponding battery cell of the cell circuit.

In some embodiments, the output filter is a third inductor.

In some embodiments, each of the AC/DC converters is a ZETA-derived converter.

In some embodiments, the battery equalizer further includes a transformer coupled between the DC/AC circuit and the AC link.

In some embodiments, a duty cycle of the active switch is controlled based on a ratio between a string voltage of the battery string and a lowest cell voltage for each of the battery cells.

According to another aspect of the invention, there is provided a battery system comprising a battery equalizer as mentioned above, and a series-connected battery string comprising a plurality of battery cells that are connected to the battery equalizer.

According to a further aspect of the invention, there is provided a method of conducting a battery equalization for a series-connected battery string. The method includes the steps of providing a first balancing current to a first battery cell in the battery string, and providing, to the first battery cell, a second balancing current which is gradually decreasing from the first balancing current. The first balancing current is based on an initial voltage difference between the first battery cell and remaining ones in the battery string. The second balancing current is gradually decreasing from the first balancing current. The second balancing current based on reduction of the voltage difference between the first battery cell and the remaining ones in the battery string. The second balancing current is further based on an AC voltage converted from a string voltage of the battery string.

In some embodiments, the AC voltage is obtained using an DC/AC converter coupled to the battery string. The DC/AC converter contains an active switch, and a first inductor connected to the active switch in series.

In some embodiments, the second balancing current is generated using an AC/DC converter that is coupled to the first battery cell. The AC/DC converter is capacitively coupled to an output of the DC/AC converter.

The invention in a further aspect provides a battery equalizer, which includes a plurality of cell circuits that are connected in parallel with each; an AC bus to which the plurality of cell circuits connects to; and a DC/AC converter connected to the AC bus. Each of the cell circuits is adapted to connect to a battery cell. In each of the cell circuits there is an AC/DC converter. AC sides of the DC/AC converter and the AC/DC converters connecting to the AC bus.

In some embodiments, the DC/AC converter contains an active switch which is the only active switch of the battery equalizer.

In some embodiments, the DC/AC converter further contains an inductor connected to the active switch.

In some embodiments, the DC/AC converter further contains coupled inductors connected to the active switch.

In some embodiments, the AC sides of the DC/AC converter and the AC/DC converters connect to the AC bus via capacitors.

In some embodiments, each of the AC/DC converters is in an input parallel output series (IPSO) configuration.

In some embodiments, each of the AC/DC converters is connected with two coupling capacitors.

In some embodiments, each of the AC/DC converters contains an inductor and a diode.

In some embodiments, each of the AC/DC converters is adapted to be connected to its corresponding battery cell via an output filter.

According to a further aspect of the invention, there is provided a battery system that includes a battery equalizer according to claim 1, and multiple battery cells connected to the battery equalizer.

According to a further aspect of the invention, there is provided a method of conducting a battery equalization. The method includes steps of providing an initial equalizing current to a plurality of battery cells; determining voltage difference(s) between the plurality of battery cells; and gradually decreasing the balancing current according to reduction of the voltage difference(s). The equalizing current supplied to each of the plurality of battery cells is determined by the AC/DC converter.

One can see that various embodiments of the invention provide an autonomous battery equalizer using capacitively-coupled ZETA-derived structure. The equalization circuit eliminates selection switches, as the output current is automatically distributed based on the difference in battery voltage. Furthermore, using a single magnetic component for the entire battery string reduces circuit size and weight significantly. The equalizer contains only one semiconductor switching device, resulting in low cost and simplified control.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figure(s), of which:

FIG. 1 illustrates a structure of battery-based energy storage.

FIG. 2a shows the block diagram of a conventional DCSS-based equalizer.

FIG. 2b shows the block diagram of a conventional MC-based equalizer.

FIG. 2c shows the block diagram of a conventional multi-winding transformer coupling based equalizer.

FIG. 3 shows a battery equalization circuit according to one embodiment of the invention, which is connected to a battery string.

FIG. 4 shows key waveforms of various circuit values in the circuit of FIG. 3 in the steady state during balancing.

FIG. 5a illustrates the operation mode of the battery equalizer of FIG. 3, when the MOSFET is turned on.

FIG. 5b illustrates the operation mode of the battery equalizer of FIG. 3, when the MOSFET is turned off.

FIG. 6 illustrates the power loss versus magnetizing inductance (Lm) for the battery equalizer of FIG. 3.

FIG. 7a shows a non-ideal model of the DC/AC converter in FIG. 3.

FIG. 7b shows voltage spikes occurred upon the switching off the MOSFET Q.

FIG. 8a shows the simulation results for four cells using the battery equalizer of FIG. 3, with the initial open-circuit voltages being 3.756, 3.558, 3.360, and 3.201V.

FIG. 8b shows the simulation results for four cells using the battery equalizer of FIG. 3, with the initial open-circuit voltages being 3.638, 3.435, 3.332, and 3.142V.

FIG. 8c shows the simulation results for four cells using the battery equalizer of FIG. 3, with the initial open-circuit voltages being 3.756, 3.558, 3.360, and 3.201V.

FIG. 8d shows the simulation results for four cells using the battery equalizer of FIG. 3, with the initial open-circuit voltages being 3.926, 3.728, 3.572, and 3.382V under discharging condition with an 400 load.

FIG. 9 shows key waveforms measured from the prototype of the battery equalizer, including those for the gate drive signal V_{gs}, inductor current i_{L1}, i_{L2}, and output voltage vₓ of the DC/AC converter.

FIG. 10a shows the experiment results for four cells at idle condition for single module balancing.

FIG. 10b shows the experiment results for four cells at a charging condition with 1 A current.

FIG. 10c shows the experiment results for four cells at a charging condition with 2 A current.

FIG. 10d shows the experiment results for four cells at a charging condition with a discharging condition with a 160 load.

FIG. 11 shows a battery equalization circuit according to another embodiment of the invention, which is connected to a battery string.

FIG. 12 shows the general circuit topology of a battery equalization circuit according to a further embodiment of the invention, which is connected to a battery string.

FIG. 13a shows a battery equalization structure containing multiple battery equalizers according to one embodiment of the invention.

FIG. 13b shows a specific implementation of the battery equalization structure in FIG. 13a.

FIG. 14 illustrates the circuit structure of the m-th module in the battery equalization structure.

FIG. 15a illustrates the operation mode of the m-th module of FIG. 14, when the MOSFET is turned on.

FIG. 15b illustrates the operation mode of the m-th module of FIG. 14, when the MOSFET is turned off.

FIG. 16a shows a simplified circuit for each of the four cell circuits in the m-th module of FIG. 14.

FIG. 16b shows the simplified circuit for discharging cell.

FIG. 16c shows the simplified circuit for charging cell when MOSFET is turned on.

FIG. 16d shows the simplified circuit for charging cell when MOSFET is turned off.

FIG. 16e shows a simplified circuit for the DC/AC circuit in the m-th module of FIG. 14.

FIG. 17 illustrates key waveforms of the battery equalization module of FIGS. 15a-15b in the steady state during balancing.

FIG. 18a shows key waveforms of the modular autonomous voltage equalizer (MAVE), including the gate drive signal V_{gs1}, inductor current i_{L11}, i_{L12}, and output voltage Vₓ₁ of DC/AC converter of module M1, when the module M1 works independently, balancing four cells.

FIG. 18b shows key waveforms of the MAVE, including the gate drive signal V_{gs2}, inductor current i_{L21}, i_{L22}, and voltage v_{C26} of coupling capacitor C₂₆, when module M2 works independently, balancing four cells.

FIG. 18c shows key waveforms of the MAVE, including drain source voltage V_{ds1} of Q₁ and V_{ds2} of Q₂, output voltage vₓ₂ of DC/AC converter of module M2, and inductor current i_{L11}, when two modules work together balancing eight cells.

FIG. 19a shows experiment results for four cells at an idle condition for single module balancing.

FIG. 19b shows experiment results for the four cells with a charging condition with 1 A current.

FIG. 19c shows experiment results for the four cells at a charging condition with 2 A current.

FIG. 19d shows experiment results for the four cells at a discharging condition with a 160 load.

FIG. 20a shows experiment results for eight cells at an idle condition for two modules balancing.

FIG. 20b shows experiment results for the eight cells at a charging condition with 1 A current.

FIG. 20c shows experiment results for the eight cells at a discharging condition with a 320 load.

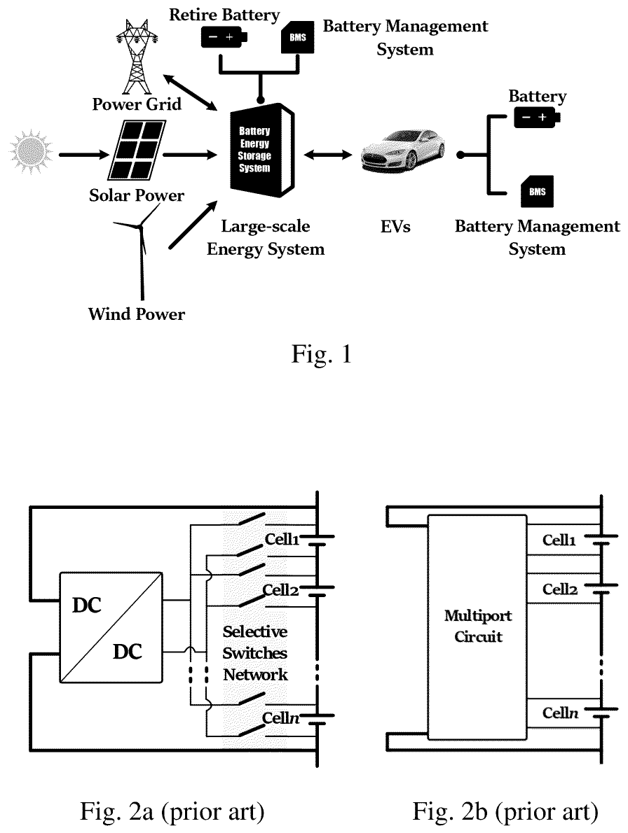

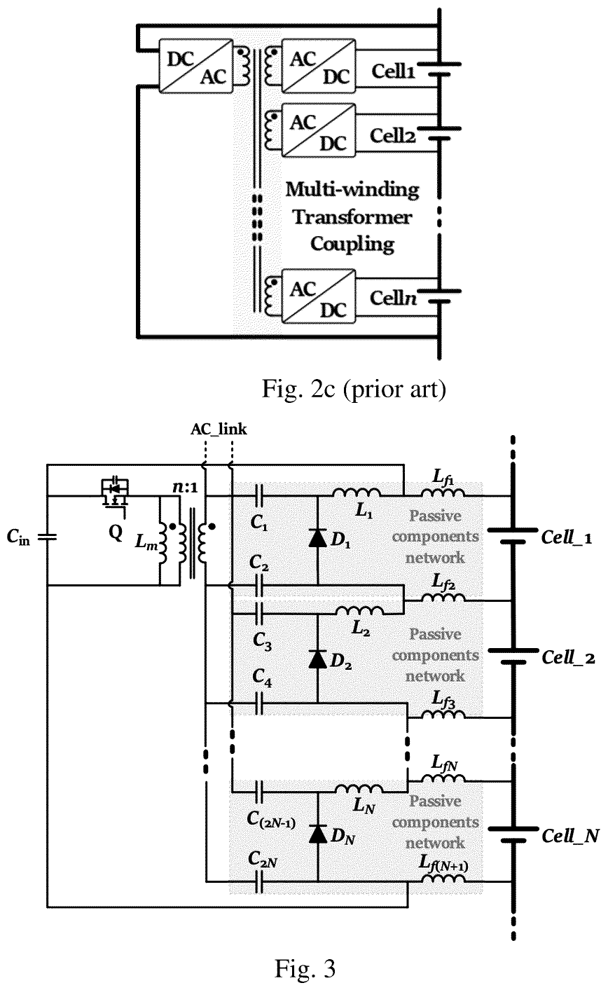

### DETAILED DESCRIPTION

The first embodiment of the invention is an autonomous battery equalization circuit that performs energy routing and equalizes the battery cell voltage of series-connected battery string. It utilizes a capacitively-coupled two-stage power conversion system. The first stage converts the DC voltage of the battery string into a high-frequency AC voltage to form an AC link. The second stage consists of diode-based rectifiers with their input connected in parallel to the AC link and their output connected to the respective battery cells. The current drawn from the first stage is shared among the rectifiers in the second stage via the AC link. As the current taken from the first stage is common to all battery cells, charging or discharging of individual battery cells is autonomously determined by the output current of the second stage, which is in turn determined by the difference between the coupling capacitor voltage and AC link voltage. The architecture only requires a single magnetic component (e.g., the inductor in the DC/AC converter) and one active switch (e.g., a MOSFET), the volume and weight of the architecture are reduced, and the control circuit of the equalizer can be simplified. No selection switches are needed, where the charging/discharging current is automatically distributed based on the difference in the battery voltages of the cells in the battery string.

FIG. 3 shows the circuit diagram of the battery equalization circuit (or simply, the battery equalizer) in the embodiment, which is connected to a string of N series-connected cells designated as Cell_₁, Cell_₂, . . . . Cell_N. Each of the N cells have its own cell voltage, and since all N cells are connected in series, a string voltage is defined as the accumulated voltages of the N cells, which is the voltage between the positive terminal of Cell_₁ and the negative terminal of Cell_N in FIG. 3. The string voltage (which is a DC voltage) is provided to the input of the battery equalizer, and in particular to two ends of the capacitor Cin in the DC/AC converter in the first stage of the battery equalizer. The capacitor Cin acts as a DC voltage source in the battery equalizer, and the capacitor Cin itself is charged by the string voltage. As will be described below, the input and output of the battery equalizer are both DC voltages, but there is the AC link in the battery equalizer that supplies AC voltage. Therefore, besides the DC/AC converter at one side of the AC link, there are also AC/DC converters at the other side of the AC link for converting AC current from the AC link to DC charging currents for the battery string, which will be described later.

The DC/AC converter contains, besides the capacitor Cin, an active switch which is a N-channel MOSFET Q that has a body diode and a parasitic body capacitor, and an inductor Lm connected to the MOSFET Q in series between the two ends of the capacitor Cin. A drain of the MOSFET Q is connected to one end of the capacitor Cin, and a source of the MOSFET Q is connected to the inductor Lm as well as to a transformer. A gate of the MOSFET Q is connected to a controller (not shown) external to the circuit of FIG. 3 which is adapted to provide driving signals to the MOSFET Q. The transformer has a turns ratio of n:1, and can be seen as a pair of coupled inductors. The primary side of the transformer is connected to the MOSFET Q and the inductor Lm, while a secondary side of the transformer is connected to the AC link. The inductor Lm acts as a magnetizing inductance, and is the only magnetic component in the entire battery equalizer.

The AC link acts as an AC bus so that the outputted AC voltage from the DC/AC converter can be shared by all cell circuits of the battery equalizer. FIG. 3 shows only three cell circuits for Cell_₁, Cell_₂ and Cell_N, but it should be noted that N could be any number that is equal to greater than 2 (in which case there are only Cell_₁ and Cell_₂), and all cell circuits in the battery equalizer preferably have identical structures. The Ncell circuits, composed of only passive components, are connected with each other in the form of parallel ZETA configuration. As such, the MOSFET Q is the only active switch in the entire battery equalizer. The plurality of cell circuits is connected in parallel with each other at their input ends, which are the ends that are coupled with the AC link. On the other hand, each cell circuit at its output end is connected to a corresponding battery cell of the battery string. The multiple cell circuits therefore effectively form an input-parallel output-series (IPOS) circuit.

Each of the N cell circuits contains an AC/DC converter that includes a diode D₁, D₂ . . . Dₙ and an inductor L₂, L_{N} . . . L_{N}. The diode and the inductor in each cell circuit is connected in series between two ends of the corresponding cell Cell_₁, Cell_₂ . . . . Cell_N. In addition, the AC/DC converter in each cell circuit is capacitively coupled, at the AC side of the AC/DC converter, to the AC link. The capacitive coupling is implemented by two capacitors in each cell circuit, for example capacitors C₁ and C₂ for the first cell circuit containing diode D₁ and inductor L₁. The two capacitors C₁ and C₂ are respectively coupled between the AC link and one of the two ends of the diode D₁. Note that the AC link in the exemplary embodiment of FIG. 3 has two wires, and each of the two capacitors C₁ and C₂ is coupled to a different one of the two wires of the AC link. The total number of capacitors used for capacitive coupling of the AC/DC converters is 2N. Functions of the capacitors coupled to the AC/DC converters include decoupling the DC component at the AC link and thus blocking DC current circulating among the AC/DC converters.

In addition, for each cell circuit, there are configured two inductors L_{f1}−L_{f(N+1)} which act as output filters for the charging currents to the battery cells. There is a respective one of the inductors L_{f1}−L_{f(N+1)} connected to each and every end of all N battery cells, and for this reason the total number of inductors L_{f1}−L_{f(N+1)} is N+1. Except for inductors L_{f1} and L_{f1}−L_{f(N+1)}, the other ones of the inductors L_{f1}−L_{f(N+1)} are each shared by two cell circuits, for example inductor L_{f2} is connected to both a positive terminal of a diode D₁ in a first cell circuit, and to an end of an inductor L₂ in a second cell circuit.

Having described the structure and components of the battery equalizer in FIG. 3, the description will now turn to the working principle of the battery equalizer. The DC/AC converter on the primary side of the transformer is used to generate a high-frequency output which, after the voltage transformation, provides an AC voltage to the AC link. Based on the structure of the DC/AC converter, the battery equalization circuit operates in discontinuous conduction mode (DCM) or boundary conduction mode (BCM), where the current through the inductor Lₘ reaches zero in every switching cycle. The structure of the battery equalizer is a ZETA-derived converter [14], where the duty cycle of the MOSFET Q is determined by the ratio between the cell voltage and the string voltage. The cell voltage here refers to the voltage of a single battery cell in the string. A higher ratio of these two voltages results in a smaller duty cycle for Q. The transformer is adapted to prevent the duty cycle from becoming too small when the number of battery cells is large.

To simplify the analysis of the circuit behavior, the battery equalizing circuit in FIG. 3 can be divided into two parts: the MOSFET Q and the transformer, and the passive components network (which contains the cell circuits). Moreover, when analyzing the circuit balancing principle, all components are considered to be ideal.

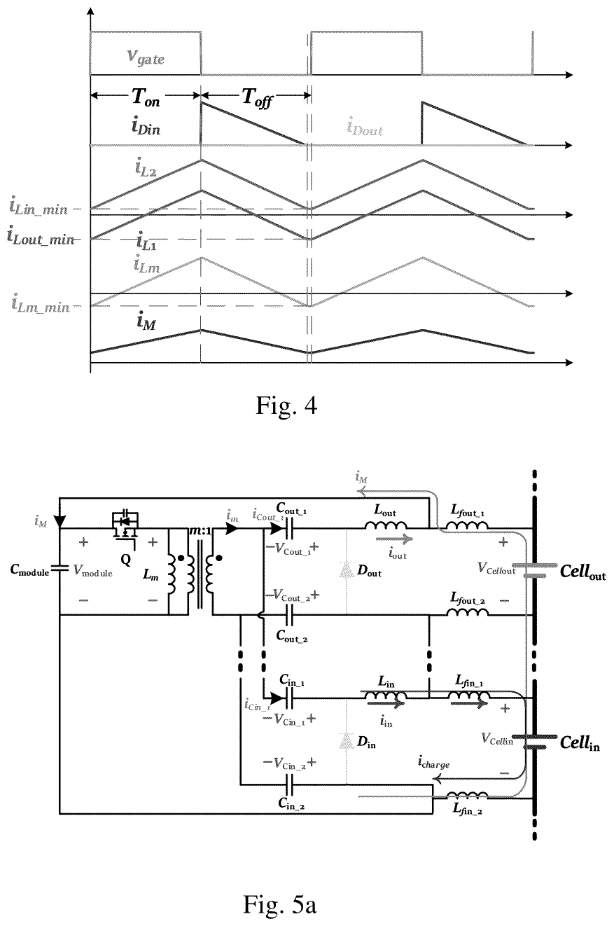

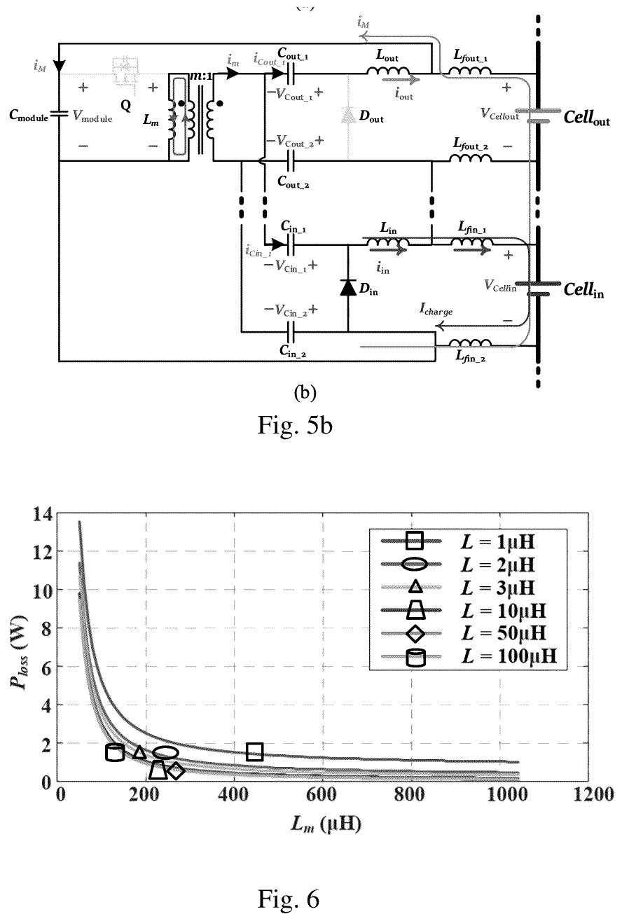

As mentioned above, the battery string provides a DC input voltage for the battery equalizer. The key waveforms of the MOSFET Q driving signal as well as various currents through the components in the steady state during balancing is shown in FIG. 4. FIGS. 5a and 5b illustrate the equivalent circuit of the equalization structure in one switching cycle, where FIG. 5a shows the operation mode when the MOSFET Q is turned on, while FIG. 5b shows the operation mode when the MOSFET Q is turned off. In FIGS. 5a and 5b, only two cells in the battery string are shown, and for demonstration purposes it is assumed that one of the cells (with a voltage of Cellₒᵤₜ) has a higher voltage than the other one of the cells (with a voltage of Cellᵢₙ). A balance of voltages of the two cells is therefore desired.

For the entire battery string, a module voltage V_{module} which is the string voltage mentioned above, can be expressed as

$$\begin{matrix}{V}_{module} = {V}_{Cellout \_ 1} + … + {V}_{Cellout \_ N} + \\ {V}_{Cellin \_ 1} + … + {V}_{Cellin \_ N} \\ = {\sum }_{k = 1}^{K} {V}_{Cellout \_ k} + {\sum }_{j = 1}^{J} {V}_{Cellin \_ j}\end{matrix} \qquad ( 1 )$$

where N is the number of battery cells as mentioned above, K is the number of net outflow cells, and J is the number of net inflow cells. The secondary side of transformer delivers an AC output, which could be in the form of voltage source, current source, or a combination of voltage or current source. The peak voltage of the AC link is expressed as

$${v}_{A C \_ link} = \frac{{\sum }_{k = 1}^{K} {V}_{Cellout \_ k} + {\sum }_{j = 1}^{J} {V}_{Cellin \_ j}}{n} \qquad ( 2 )$$

wherein n is the turns ratio of the transformer as mentioned above.

In the passive component network, all the cell circuits are connected at their input ends in parallel, therefore the current of the secondary side of the transformer, which is iₘ, is equal to the sum of the currents of all coupling capacitors. There are two 2N coupling capacitors in total as mentioned above, and the relationship between iₘ and individual currents passing through the coupling capacitors can be shown as

$$\begin{matrix}{i}_{m} = {ni}_{M} \\ = {i}_{Cout \_ 1} + … + {i}_{Cout \_ K} + \\ {i}_{Cin \_ 1} + … + {i}_{Cin \_ J} \\ = {\sum }_{k 1}^{K} {i}_{Cout \_ k} + {\sum }_{j = 1}^{J} {i}_{Cin \_ j}\end{matrix} \qquad ( 3 )$$

For each cell circuit, at any time one of the equations (4a) and (4b) will be true. For example, in FIG. 5a for the upper one of the two cells in the figure, equation (4a) will apply, for the lower one of the two cells in the figure, equation (4b) will apply.

$${v}_{A C \_ link} {i}_{m} = {i}_{Cout} {V}_{Cellout} \qquad ( 4 a )$$

$${v}_{A C \_ link} {i}_{m} = {i}_{Cin} {V}_{Cellin} \qquad ( 4 b )$$

By using equations (2)-(4b), the output current of each cell circuit at any time is provided as shown by one of equations (5a) and (5b). For example, in FIG. 5a for the upper one of the two cells in the figure, equation (5a) will apply, for the lower one of the two cells in the figure, equation (5b) will apply.

$${i}_{out} = \frac{{\sum }_{k = 1}^{K} {V}_{Cellout \_ k} + {\sum }_{j = 1}^{J} {V}_{Cellin \_ j}}{{nV}_{Cellout}} {i}_{Cout} \qquad ( 5 a )$$

$${i}_{i n} = \frac{{\sum }_{k = 1}^{K} {V}_{Cellout \_ k} + {\sum }_{j = 1}^{J} {V}_{Cellin \_ j}}{{nV}_{Cellin}} {i}_{Cin} \qquad ( 5 a )$$

The input current (i_{M}) of the battery equalizer is the current drawn from the battery string. For each battery cell, the balancing current at any time is therefore provided according to one of equations (6a) and (6b).

$${i}_{B \_ out} = {i}_{out} - {i}_{M} \qquad ( 6 a )$$

$${i}_{B \_ i n} = {i}_{i n} - {i}_{M} \qquad ( 6 b )$$

According to equations (5a)-(6b), the power for equalizing each battery cell can be expressed as one of equations (7a) and (7b) at any time.

$${P}_{balancing \_ out} = {V}_{Cellout \_ k} {i}_{balancing \_ out} = \frac{{\sum }_{k = 1}^{K} {V}_{Cellout \_ k} + {\sum }_{j = 1}^{J} {V}_{Cellin \_ j}}{n} {i}_{Cout \_ k} - {V}_{Cellout \_ k} {i}_{M} \qquad ( 7 a )$$

$${P}_{balancing \_ in} = {V}_{Cellin \_ k} {i}_{balancing \_ in} = \frac{{\sum }_{k = 1}^{K} {V}_{Cellout \_ k} + {\sum }_{j = 1}^{J} {V}_{Cellin \_ j}}{n} {i}_{Cin \_ k} - {V}_{Cellin \_ k} {i}_{M} \qquad ( 7 b )$$

When the MOSFET Q is turned on within Tₒₙ, as shown in FIG. 5a, the magnetizing inductance (which is the inductor Lₘ) is being charged. The voltage across Lₘ is

$${V}_{Lm} = {V}_{module} \qquad ( 8 )$$

For the inductor Lₒᵤₜ in FIGS. 5a and 5b, its inductor voltage is represented by the equation (9a). For the inductor Lᵢₙ in FIGS. 5a and 5b, its inductor voltage is represented by the equation (9b).

$${V}_{Lout} = \frac{{\sum }_{k = 1}^{K} {V}_{Cellout \_ k} + {\sum }_{j = 1}^{J} {V}_{Cellin \_ j}}{n} + {V}_{Cout 1} - {V}_{Cout 2} - {V}_{Cellout} \qquad ( 9 a )$$

$${V}_{Lin} = \frac{{\sum }_{k = 1}^{K} {V}_{Cellout \_ k} + {\sum }_{j = 1}^{J} {V}_{Cellin \_ j}}{n} + {V}_{Cm 1} - {V}_{Cm 2} - {V}_{Cellin} \qquad ( 9 b )$$

While the MOSFET Q is turned on within Tₒₙ, all diodes D₁, D₂ . . . Dₙ are turned off, and the currents of the coupling capacitors Cₒᵤₜ₁ and Cₒᵤₜ₂ are respectively represented by the equations (10a) and (10b).

$${i}_{Cout 1} = - {i}_{Lout} \qquad ( 10 a )$$

$${i}_{Cm 1} = - {i}_{Lin} \qquad ( 10 b )$$

When the MOSFET Q is turned off within T_{off}, as shown in FIG. 5b the charging cell circuit (for Cellᵢₙ) and cell discharging circuit (for Cellₒᵤₜ) have different operating modes, as shown in FIG. 5b, and Lₘ is being discharged. The voltage across Lₘ is

$$\begin{matrix}{V}_{Lm} = - n ( {V}_{Cin 1} - {V}_{Cin 2} ) \\ = n ( - {V}_{Cout 1} + {V}_{Cout 2} + {V}_{Lout} + {V}_{Cellout} )\end{matrix} \qquad ( 11 )$$

At this time, the diode Dᵢₙ in the circuit of the battery with the lowest voltage (as shown in FIG. 5b with a solid black color) is turned on first. The voltage of the AC link is clamped, and the other diodes (e.g. Dₒᵤₜ) are turned off (as shown in FIG. 5b with a grey color). V_{Lout} and V_{Lin} can be expressed as

$${V}_{Lout} = - {V}_{Cellout} + {V}_{Cout 1} - {V}_{Cout 2} + \frac{{V}_{Lm}}{n} \qquad ( 12 )$$

$${V}_{Lin} = - {V}_{Cellin} \qquad ( 13 )$$

In addition, the relationships between currents of the coupling capacitors are given by

$${i}_{Cout 1} = - {i}_{Lout} \qquad ( 14 )$$

$${\sum }_{k = 1}^{K} {i}_{Cout \_ k} + {\sum }_{j = 1}^{J} {i}_{Cin \_ j} = {ni}_{Lm} \qquad ( 15 )$$

Since the battery equalization circuit operates at BCM, the period of time during which the inductance current remains constant can be neglected.

$$- ( \frac{{V}_{Cellin}}{2 {L}_{m}} ( 1 - D ) {T}_{s} + {I}_{Lm \_ min} ) D + [ n ( \frac{{V}_{module}}{2 {L}_{m}} {DT}_{s} + {I}_{Lm \_ min} ) + ( \frac{{V}_{module}}{2 {nL}_{out}} ( 1 - D ) {T}_{s} + {I}_{Lout \_ min} ) ] ( 1 - D ) = 0. \qquad ( 16 )$$

Equation (16) illustrates the principle of capacitor amp-second balance of Cᵢₙ₁, where Dis the duty cycle of the switch, and I_{Lout_min} and I_{Lin_min} are minimum currents of inductors Lₒᵤₜ and Lᵢₙ, respectively. According to Kirchoff's current law (“KCL”),

$${I}_{Lout \_ min} + {I}_{Lin \_ min} = - {nI}_{Lm \_ min} . \qquad ( 17 )$$

During equalization, it is assumed that the current of K battery cells is a net outflow and the current of J battery cells is a net inflow. Equation (17) can be expressed as

$${KI}_{Lout \_ min} + {JI}_{Lin \_ min} = - {nI}_{Lm \_ min} . \qquad ( 18 )$$

By using (15), (16), and (18), the minimum current of Lₒᵤₜ can be derived as

$${I}_{Lin \_ min} = K \frac{{\sum }_{k = 1}^{K} {V}_{Cellout \_ k} + {\sum }_{j = 1}^{J} {V}_{Cellin \_ j}}{2 nL} {( 1 - D )}^{2} {T}_{s} + n \frac{{\sum }_{k = 1}^{K} {V}_{Cellout \_ k} + {\sum }_{j = 1}^{J} {V}_{Cellin \_ j}}{2 {L}_{m}} D ( 1 - D ) {T}_{s} - \frac{{V}_{Cellin}}{2 L} D ( 1 - D ) {T}_{s} \qquad ( 19 )$$

where L=Lₒᵤₜ=Lᵢₙ. Similarly, according to capacitor Cₒᵤₜ₁ amp-second balance, the minimum current of Lₒᵤₜ can be derived as

$${I}_{Lout \_ min} = - \frac{{\sum }_{k = 1}^{K} {V}_{Cellout \_ k} + {\sum }_{j = 1}^{J} {V}_{Cellin \_ j}}{2 nL} ( 1 - D ) {T}_{s} \qquad ( 20 )$$

The average current of the inductor Lᵢₙ can be calculated as

$${I}_{Lin} = \frac{{V}_{Cellin}}{2 L} ( 1 - D ) {T}_{s} + {I}_{Lin \_ min} . \qquad ( 21 )$$

The average current of the magnetizing inductance (which is the inductor Lₘ) is the discharging current of the battery string during equalization, and it can be shown that

$${I}_{M} = {D}^{2} {T}_{s} \frac{{\sum }_{k = 1}^{K} {V}_{Cellout \_ k} + {\sum }_{j = 1}^{J} {V}_{Cellin \_ j}}{2} \times ( \frac{1}{{L}_{m}} + \frac{N}{{n}^{2} L} ) \qquad ( 22 )$$

Combining equations (6), (21) and (22), the balancing current for each cell can be shown as

$${i}_{balancing} = \frac{{\sum }_{k = 1}^{K} {V}_{Cellout \_ k} + {\sum }_{j = 1}^{J} {V}_{Cellin \_ j}}{{nV}_{Cell \_ k}} {i}_{cin \_ j} - {D}^{2} {T}_{s} \frac{{\sum }_{k = 1}^{K} {V}_{Cellout \_ k} + {\sum }_{j = 1}^{J} {V}_{Cellin \_ j}}{2} \times ( \frac{1}{{L}_{m}} + \frac{N}{{n}^{2} L} ) \qquad ( 23 )$$

Therefore, due to the different balancing current (i_{balancing}) for each cell, balancing of all battery cells in the battery string can be achieved.

In the next section, the design methodology of the battery equalizer in FIG. 3 will be described. As mentioned above, for the battery equalizer, during its battery cell equalization process, the equalization current gradually decreases until the voltage differences between the battery cells are eliminated. Consequently, the initial value of the equalization current can only be calculated based on the distribution of initial voltages of the battery cells before equalization. From equations (22) and (23), it is found that the equalization current is not only influenced by the duty cycle and voltage distribution but also significantly affected by the inductance value. The inductance value herein refers to that of the inductor (L₁, L₂ . . . . L_{N}) next to the diode (D₁, D₂ . . . . D_{N}) on the secondary side, and an example of the inductance value will be 10 uH. A higher current can achieve faster equalization, but the presence of diodes leads to increased conduction losses. In addition, the voltage ripple of coupling capacitors also affects equalization speed and efficiency. The relationship between the component values and losses is studied. In addition, the design of the transformer needs to consider the number of battery cells. Zero-voltage-switching (ZVS) of the switch is considered.

There are two main sources of loss in the equalizer of FIG. 3, which are diode losses and magnetic component loss, that will dominate efficiency of the battery equalizer. The magnetic component loss can be split into coil loss and core loss. In the circuit design, trade-offs need to be made among conduction losses, switching speed, and component size.

The diode loss can be calculated as

$${P}_{d i o d e} = {V}_{D} \frac{{V}_{Cellin}}{2 L} {( 1 - D )}^{2} {T}_{s} \qquad ( 24 )$$

where V_{D} is the forward voltage drop for diodes. The coil loss of magnetic components can be calculated as

$${P}_{coil} = {R}_{coupL \_ coil} {I}_{discharge}^{2} + {R}_{L \_ coil} {I}_{L}^{2} \qquad ( 25 )$$

Therefore, the conduction loss can be expressed as

$${P}_{l o s s} = {P}_{d i o d e} + {P}_{coil} \qquad ( 26 )$$

The conduction loss versus magnetizing inductance (Lₘ) is depicted in FIG. 6. It can be observed that when the magnetizing inductance (Lₘ) is greater than 200 ρH, the conduction loss significantly decreases. Additionally, when the inductance (Lₖ) exceeds 10 μH, the reduction in loss is not significant.

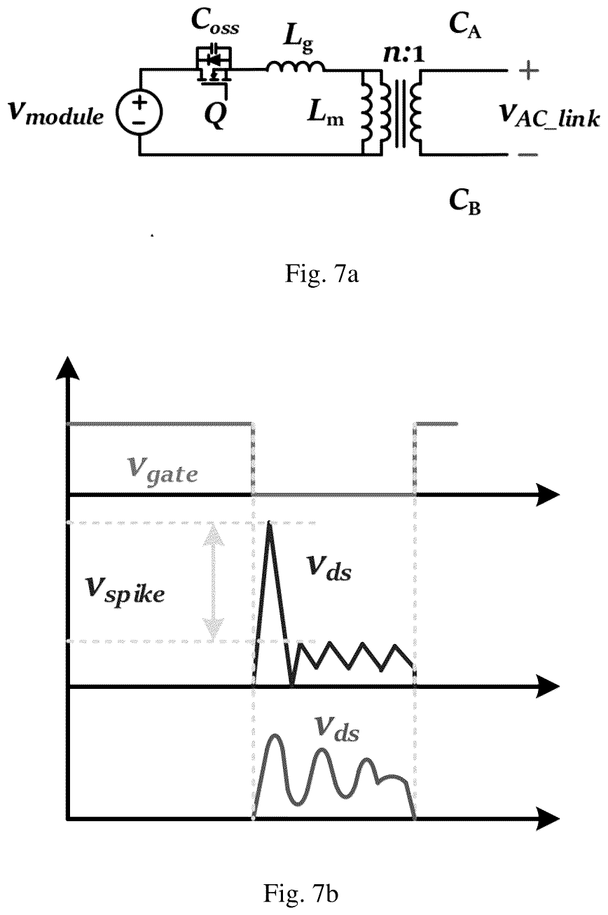

Due to the non-ideal nature of the transformer in the experimental setup, the impact of the leakage inductance is studied. The non-ideal model of the DC/AC converter is depicted in FIG. 7a. As shown in FIG. 7b, the leakage inductance results in the occurrence of voltage spikes upon the switching off switch Q. The spike voltage can be calculated as

$${V}_{spike} = {L}_{g} \frac{d i}{d t} \qquad ( 27 )$$

The high voltage spike resulting from the sudden drop of current to zero can potentially damage the MOSFET. Therefore, it is necessary to design the Cₒₛₛ to suppress the voltage spike. The measured leakage inductance is 2□H. According to ΔQ=Cₒₛₛ Vₛₚᵢₖₑ, Cₒₛₛ, Cₒₛₛ is chosen as 2000 pF.

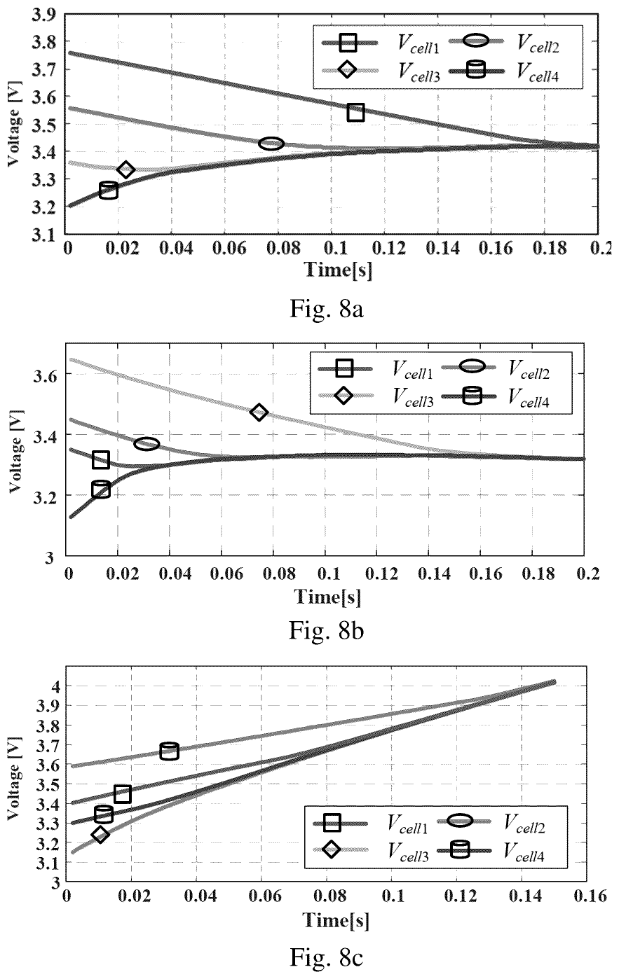

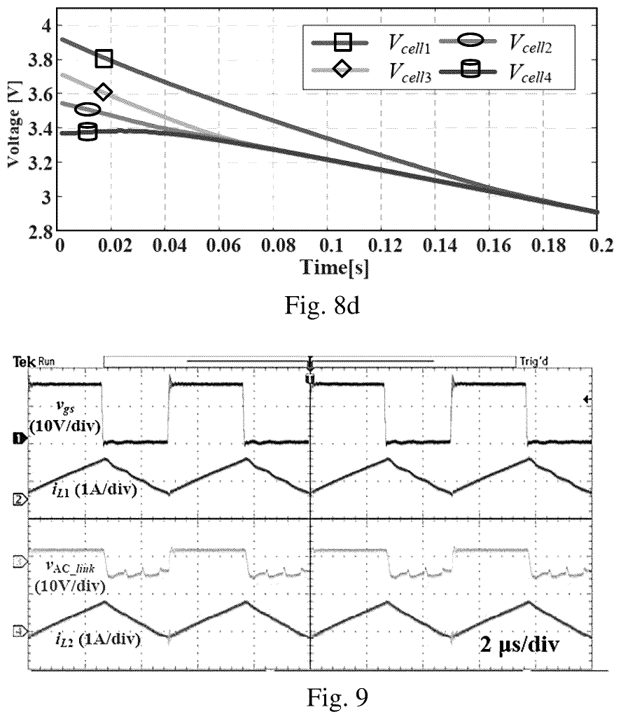

To validate the analysis and design of the battery equalizer in FIG. 3, A circuit to balance four mismatched capacitors is designed in Altair® PSIM. Four series-connected capacitors with 0.1 F are used to simulate the battery cells in order to shorten the simulation time. The initial voltage of series-connected capacitors is 3.756, 3.558, 3.360, and 3.201V, respectively, as shown in FIG. 8a. After 0.2 s balance, the voltage of series-connected capacitors is 3.410V. The initial voltage of series-connected capacitors is 3.638, 3.435, 3.332, and 3.142V, respectively, as shown in FIG. 8b. After 0.2 s balance, the voltage of series-connected capacitors converges to 3.351V. The initial voltage of series-connected capacitors is 3.756, 3.558, 3.360, and 3.201V, respectively, as shown in FIG. 8c. The battery string is subjected to a 0.5 A charging current. After 0.15 s balance, the voltage of series-connected capacitors converges to 4.005V. The initial voltage of series-connected capacitors is 3.926, 3.728, 3.572, and 3.382V, respectively, as shown in FIG. 8d. The battery string is discharged by a 40Ω load. After 0.2 s balance, the voltage of series-connected capacitors converges to 2.910V. The results of four simulations show that the battery equalization circuit is adapted to realize the balancing functions during cell charging and discharging process.

Subsequently, a prototype of the battery equalizer according to FIG. 3 is built and tested. Four retired 2600 mAh Samsung ICR18650 lithium-ion battery cells are employed in the prototype. The circuit parameters are summarized in Table I. The turns ratio of the transformer in the prototype is 4.5:1. The number of cell circuits or the number of module layers can be adjusted according to the number of battery cells. Furthermore, in order to enhance the conversion efficiency of the equalizer, low forward voltage power Schottky diodes (30BQ015) are employed. The voltage data are recorded by a data logger (Keysight 34970 A).

TABLE I
CRITICAL DESIGN PARAMETERS

| Component | Parameters | |
|---|---|---|
| MOSFET (Q [symbol] ) | BSC320N20N | |
| MCU | STM32F407 | |
| Diode (D [symbol] ) | 30BQ015 SCHOTTKY | |
| Battery | ICR18650 | |
| Coupled inductor turns ratio (n) | 4.5:1 | |
| Magnetizing inductance (L [symbol] ) | 220 | μH |
| Switching frequency (f [symbol] ) | 200 | kHz |
| Coupling capacitor (C [symbol] ) | 13 | μF |
| Inductor (L [symbol] ) | 10 | μH |
| Filter inductor (L [symbol] ) | 4.7 | μH |

[symbol]

indicates data missing or illegible when filed

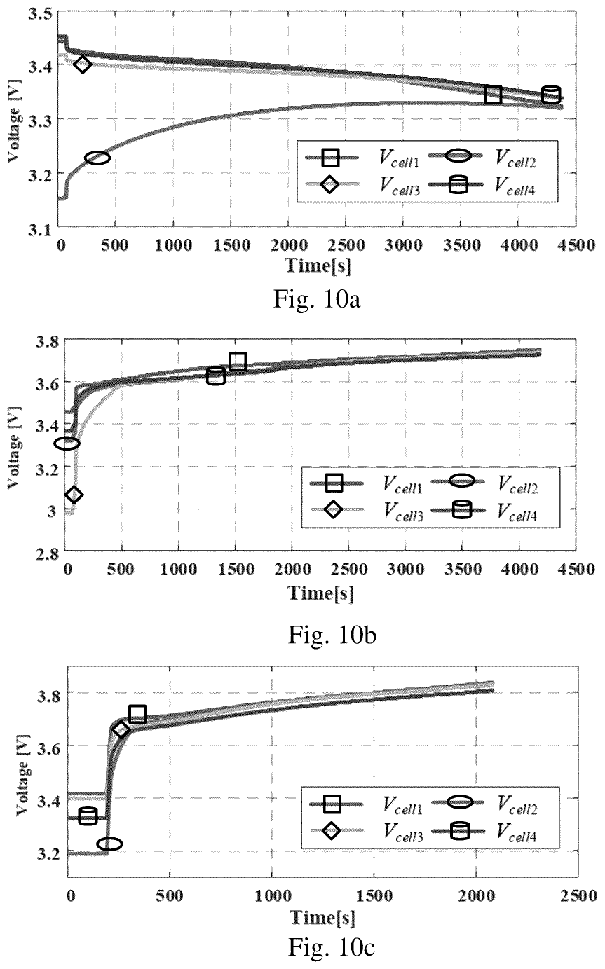

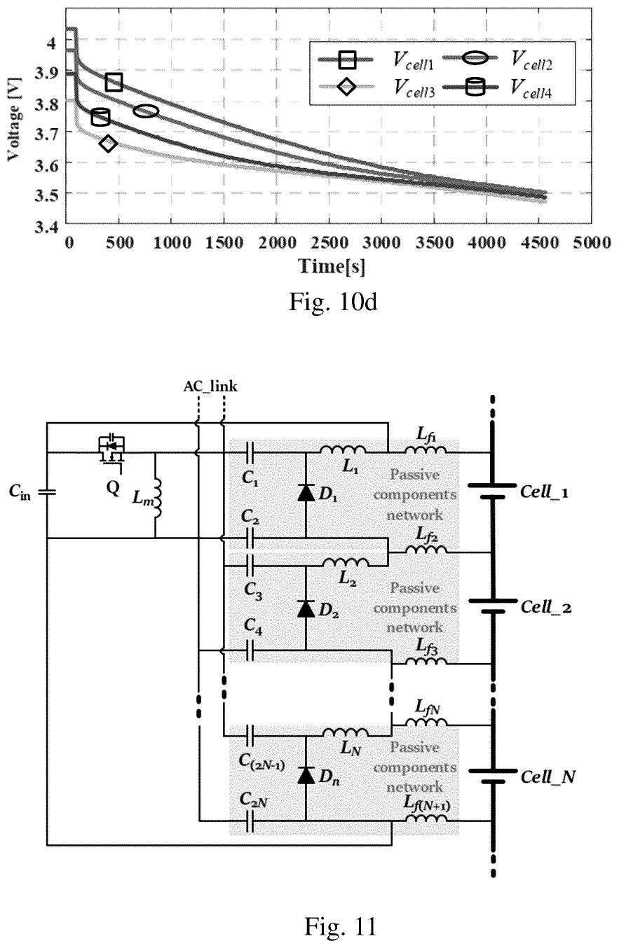

FIG. 9 shows the key waveforms of the prototype of the equalizer. The inductors in the AC/DC converters exhibit varying DC biases, due to variations in battery cell voltages. FIG. 10 depicts the probed voltage of four battery cells in the experiment. These four battery cells are grouped as one battery string, and which is balanced by one equalizer module (which is the prototype). FIG. 10a shows the equalization result under the static condition for four cells whose initial voltages are about 3.452V, 3.442V, 3.419V, and 3.153V, respectively. The equalization circuit reduces the voltage difference from 299 mV to 18 mV in 4300 s. In FIGS. 10b and c, the balancing experiments are conducted with 1 A and 2 A charging current. The initial voltage differences are 479 mV and 229 mV. The voltage difference is lower than 20 mV after equalization. FIG. 10d shows the equalization result during the discharging process with a 16Ω load.

In summary, the exemplary embodiment described above and illustrated in FIGS. 3-10d provides an autonomous battery equalizer using capacitively-coupled ZETA-derived structure. The equalization circuit eliminates selection switches, as the output current is automatically distributed based on the difference in battery voltage. Furthermore, using a single magnetic component for the entire battery string reduces circuit size and weight significantly. The equalizer contains only one semiconductor switching device, resulting in low cost and simplified control. The operation of the MOSFET as the active switch is pulse-width modulated, which simplifies the entire circuit design and reduces the control complexity. In conventional battery equalizer, the State of Health (SOH) of the battery cells is adversely affected by alternating current in the equalization process. However, the equalizer according to the exemplary embodiment described offers DC charging or discharging current, which greatly reduces damages to the battery cells and thus preserves the SOH. Furthermore, the battery equalizer can be modularized. Equalization can be achieved either within the module or module-to-module (M2M). Thus, the structure is scalable that can be applied to various voltage level systems.

It should be noted that although the battery equalizer in FIG. 3 contains a transformer (coupled inductors) before the AC link, such a transformer is only optional, and the invention should not be limited by the configuration of the transformer in the circuit. FIG. 11 shows another embodiment of the invention which has a circuit structure generally similar to that of FIG. 3, but without a transformer. As mentioned previously, the transformer may prevent the duty cycle from becoming too small when the number of battery cells in the battery string is large, but it is not absolutely necessary in all circumstances in particular when the number of battery cells is small.

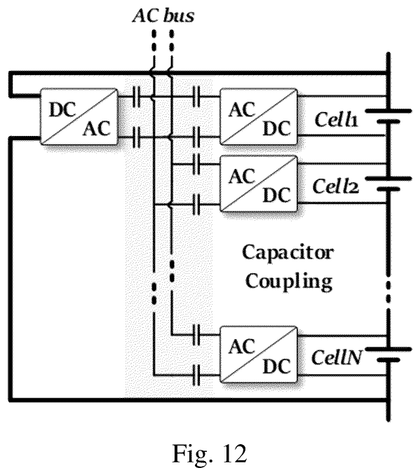

Turning to FIG. 12, which shows a general circuit topology of a battery equalizer according to a further embodiment of the invention. Compared to the battery equalizer circuit in FIG. 11, the main difference in the battery equalizer in FIG. 12 is that there are not only coupled capacitors in the cell circuits that are connected to the AC/DC converters, but there are also two coupled capacitors connected between the DC/AC converter and the AC link, which are used to decouple the DC component from the output of the DC/AC converter. The AC link is shared among multiple modules (i.e., multiple cell circuits), with each module being connected to the AC link via two capacitors. The battery string shown in FIG. 12 has N AC/DC converters coupled by 2N capacitors. These AC/DC converters in cell circuits are connected as IPSO. Multi-winding transformers are replaced with capacitors, which effectively reduce the size of the circuit and make it easier to implement in large-scale battery systems.

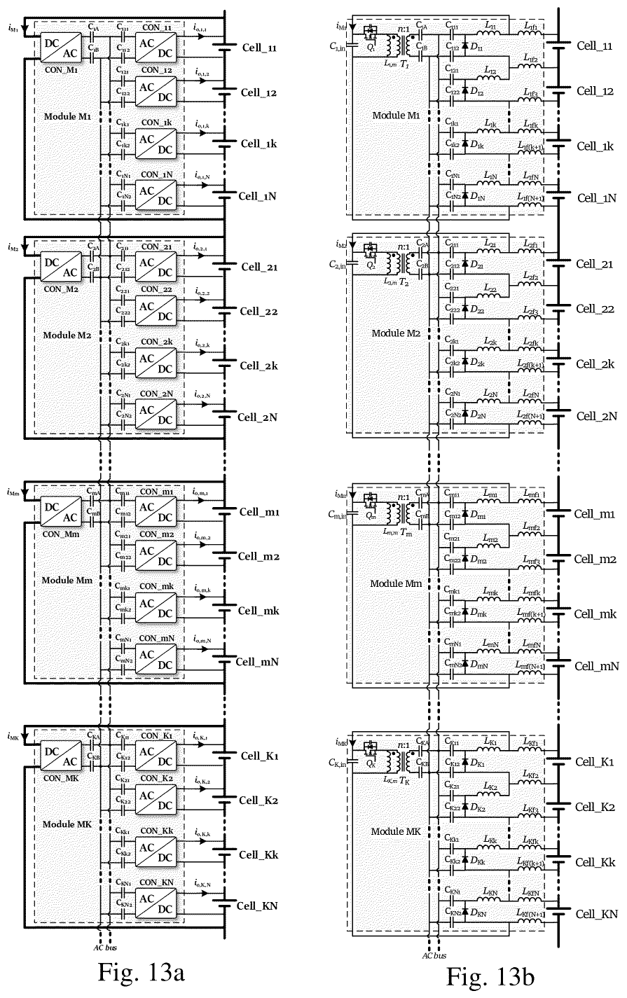

Turning to FIG. 13a, which shows the block diagram of a multi-module battery equalization structure, where each of the module is based on the configuration of the battery equalization circuit shown in FIG. 12. The battery equalization structure in FIG. 13 does not require external energy source, and it is used to balance the voltage of multiple battery cells, namely Cell_11, Cell_12, . . . , Cell_1N, Cell_21, Cell_22, . . . , Cell_2N, . . . , Cell_m1, Cell_m2, . . . , Cell_mN, Cell_K1, CellK2, . . . , Cell_KN, which are connected in series to form a battery string. The cells are divided into K groups and each group has N battery cells. Each group is controlled by a battery balancing module. Thus, there are totally K modules, labeled by M1, M2, . . . , and MK.

The structure and operation of the one of the four modules in FIG. 13a, which is the third module Mm in the figure, will be described as an example. The module Mm consists of a single front-stage DC/AC converter “CON_Mm”, and multiple AC/DC converters, namely CON_m1, CON_m2, . . . , CON_mN. The input terminals of CON_Mm is connected across the battery string formed by the battery cells Cell_m1, Cell_m2, . . . . Cell_mN. The input current of CON_Mm, i_{Mm}, is controlled. The output of CON_Mm delivers an AC output, which could be in the form of voltage source, current source, or a combination of voltage or current source. It is connected to a bus, namely AC bus, via the capacitors C_{mA} and C_{mB}, which are used to decouple the DC component from the output of CON_Mm. The bus is shared among multiple modules, with each module being connected to the bus via two capacitors.

Each of the four modules in FIG. 13a consists of N AC/DC converters, which are labeled as CON_11, CON_12, . . . , CON_1N, CON_21, CON_22, . . . . CON_2N, . . . , CON_m1, CON_m2, . . . . CON_mN, . . . , CON_K1, CON_K2, . . . . CON_KN. Each converter is connected to the bus via multiple series capacitors, Cₘ₁₁, Cₘ₁₂, Cₘ₂₁, Cₘ₂₂, . . . , Cₘₖ₁, Cₘₖ₂, . . . , C_{mN1}, C_{mN2}, which are used to decouple the DC component at the bus and thus block DC current circulating among the AC/DC converters. Each AC/DC converter is used to control the charging or discharging state of the connected battery cell. For example, for cell k in module m, let the output current of the AC/DC converter be i_{o.m.k}. Then, if i_{o.m.k} is larger than i_{Mm}, cell k will undergo charging process. Conversely, if i_{o.m.k} is smaller than i_{Mm}, cell k will undergo discharging process. Thus, the structure is like an “energy router and redistributor” which allows each cell to be discharged to or charged by other cells via the bus. By programming the input current of each module, i.e., i_{Mm}, to control the amount of energy from the associated battery string processed by the DC/AC converter to the bus and the output current of individual AC/DC converter to control the above-described charging or discharging process. For the sake of illustration, let the battery cell Cell_m2 need to be charged. All AC/DC converters, except CON_m2, will deliver zero average output current. All or part of modules have the input currents, i.e., i_{M1}, i_{M2}, . . . , i_{MK}, be controlled to deliver energy to the bus.

The “energy router and redistributor” structure is general that individual battery can be programmed to a defined voltage level. It is also applicable for other types of energy storage devices, such as capacitors, where individual capacitor might require voltage control. It should also be noted that the numbers of battery cells in all modules are unnecessary to be the same.

Based on the battery equalization structure in FIG. 13a, a specific implementation of the battery equalization structure is developed which is shown in FIG. 13b. The battery equalization structure in FIG. 13b contains coupled inductors (which form transformers) in each of the four modules, and the coupled inductors are placed between the DC/AC converter and the two capacitors for the DC/AC converter. In particular, each of the DC/AC converters in FIG. 13b is realized by an input capacitor C_{m,in}, a semiconductor switch Qₘ, coupled inductors Tₘ, and the two decoupling capacitors C_{mA} and C_{mB}. The input of each DC/AC converter is connected to a string of battery cells through two filtering inductors and its output is connected to an AC bus. The coupled inductors Tₘ has the magnetizing inductance L_{m,m}. Each of the AC/DC converters in FIG. 13b is realized by a diode Dₘₖ, an inductor Lₘₖ, and filter inductors L_{mfk} and L_{mf(k+1)}.

The energy redistribution for battery cells connected to each module can be obtained by driving the MOSFET (Qₘ) using pulse width modulation technique. The circuit operates in either the DCM mode or BCM mode. The single cell circuit operation principle is similar to a ZETA converter.

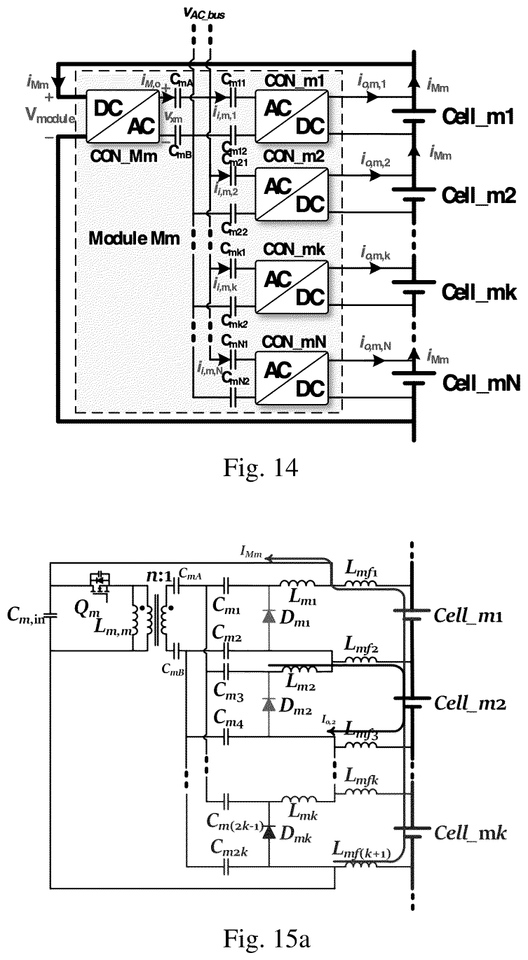

FIG. 14 shows the circuit structure of the m-th module in the battery equalization structure in FIG. 13a. The whole battery string provides the input voltage for the single module. The module voltage V_{module} can be expressed as

$${V}_{m o d u l e} = {V}_{Cell \_ m 1} + … + {V}_{Cell \_ mN} = {\sum }_{k = 1}^{N} {V}_{Cell \_ mk} \qquad ( 28 )$$

The output of the DC/AC converter, CON_Mm, delivers an AC output, which could be in the form of voltage source, current source, or a combination of voltage and current sources. The output voltage of CON_Mm, Vₘₓ, is expressed as

$${v}_{xm} = \frac{{\sum }_{k = 1}^{N} {V}_{Cell \_ mk}}{n} \qquad ( 29 )$$

where n is voltage ratio of CON_Mm. All AC/DC converters, i.e., CON_m1 to CON_mN, have their inputs connected in parallel. Thus,

$${i}_{M , o} = n {i}_{M m} = {i}_{i , m , 1} + … + {i}_{i , m , N} = {\sum }_{k = 1}^{N} {i}_{i , m , k} . \qquad ( 30 )$$

For each AC/DC converter,

$${v}_{mx} {i}_{i , m , k} = {i}_{o , m , k} {V}_{Cell \_ mk} . \qquad ( 31 )$$

By using equations (29)-(31), the output current of the AC/DC converters can be shown to be

$${i}_{o , m , k} = \frac{{\sum }_{k = 1}^{N} {V}_{Cell \_ mk}}{{nV}_{Cell \_ mk}} {i}_{i , m , k} \qquad ( 32 )$$

The equalization current for each battery cell is expressed as

$${i}_{B , m , k} = {i}_{o , m , k} - {i}_{M m} \qquad ( 33 )$$

According to equations (32) and (33), the power for equalizing each battery cell can be expressed as

$${V}_{Cell \_ mk} {i}_{B , m , k} = \frac{{\sum }_{k = 1}^{N} {V}_{Cell \_ mk}}{n} {i}_{i , m , k} - {V}_{Cell \_ mk} {i}_{Mm} \qquad ( 34 )$$

During the equalization process, the output power is equal to the input power for the battery string. Therefore,

$${V}_{Cell \_ m 1} {i}_{B , m , 2} + … + {V}_{Cell \_ mk} {i}_{B , m , k} + {V}_{Cell \_ mN} {i}_{B , m , N} = 0 \qquad ( 35 )$$

$$\frac{{\sum }_{k = 1}^{N} {V}_{Cell \_ mk} {\sum }_{k = 1}^{N} {i}_{i , m , k}}{n} = {i}_{M m} {\sum }_{k = 1}^{N} {V}_{Cell \_ mk} \qquad ( 36 )$$

According to equation (34), the equalization current can be expressed as

$${i}_{B , m , k} = \frac{{\sum }_{k = 1}^{N} {V}_{Cell \_ mk}}{n {V}_{Cell \_ mk}} {i}_{i , m , k} - \frac{1}{n} {\sum }_{k = 1}^{N} {i}_{i , m , k} \qquad ( 37 )$$

Equation (37) can also be shown as

$${i}_{B , m , k} = {Ai}_{i , m , k}$$

$$where {i}_{B , m , k} = {[ \begin{matrix}{i}_{B , m , 1} & {i}_{B , m , 2} & … & {i}_{B , m , N}\end{matrix} ]}^{T} , {i}_{i , m , k} = {[ \begin{matrix}{i}_{i , m , 1} & {i}_{i , m , 2} & … & {i}_{i , m , N}\end{matrix} ]}^{T} and$$

$$A = [ \begin{matrix}\frac{{\sum }_{k = 1}^{N} {V}_{Cell \_ mk}}{{nV}_{Cell \_ mk}} - \frac{1}{n} & - \frac{1}{n} & … & - \frac{1}{n} \\ - \frac{1}{n} & \frac{{\sum }_{k = 1}^{N} {V}_{Cell \_ mk}}{{nV}_{Cell \_ m 2}} - \frac{1}{n} & … & - \frac{1}{n} \\ ⋮ & ⋮ & ⋱ & ⋮ \\ - \frac{1}{n} & - \frac{1}{n} & … & \frac{{\sum }_{k = 1}^{N} {V}_{Cell \_ mk}}{{nV}_{Cell \_ mN}} - \frac{1}{n}\end{matrix} ]$$

The input current of AC/DC converter i_{i,m,k} can be calculated by input impedance of the circuit, which is circuit-specific.

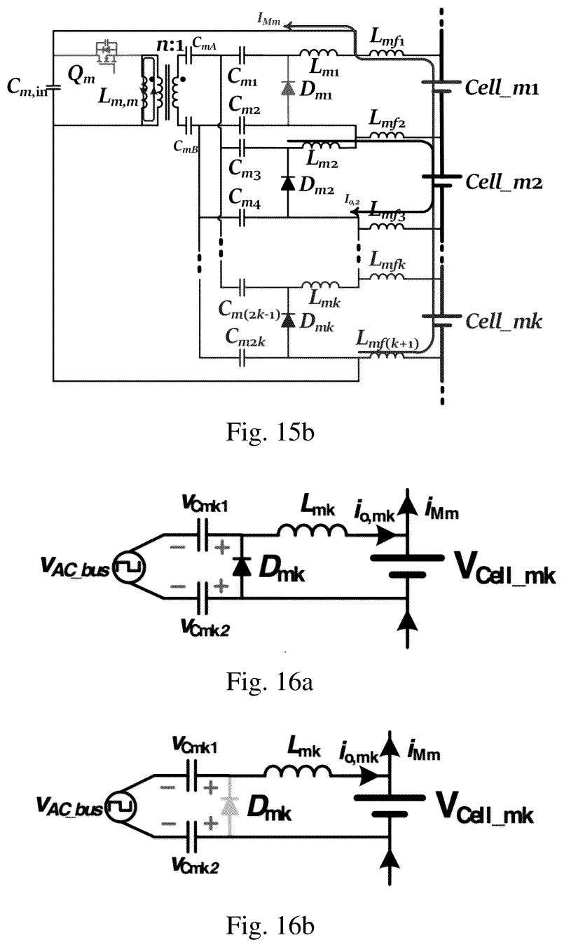

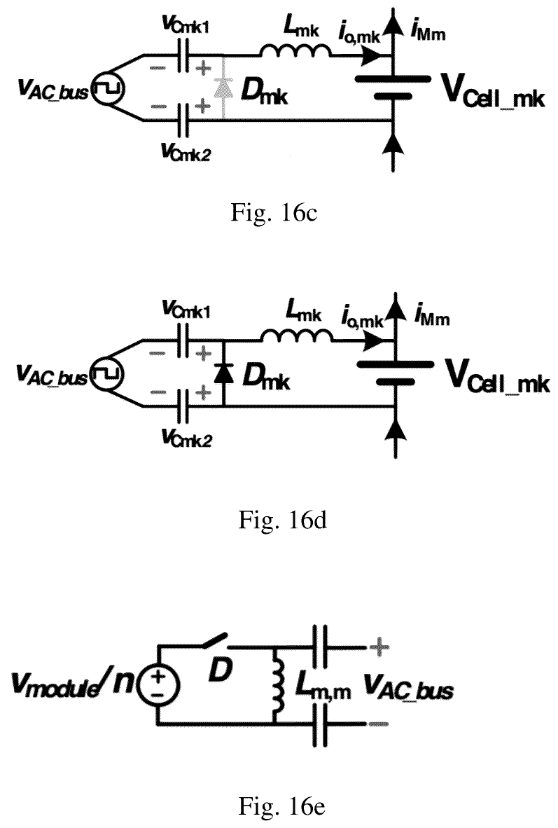

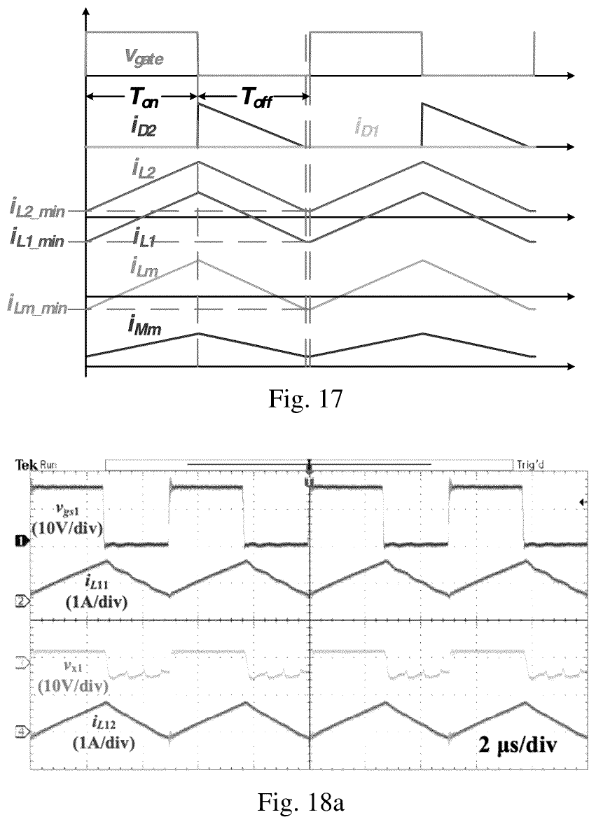

FIGS. 15a and 15b illustrate an equivalent circuit of the equalization structure in one switching cycle. The simplified circuit for each AC/DC circuit is shown in FIG. 16a-16e. For the sake of simplicity, the filter inductor is neglected in the analysis. In addition, FIG. 17 shows the key waveforms. The AC/DC converters operate in different modes, because of variations in the initial cell voltage. Considering the scenario where Cell_m1 has a net current flowing out, and Cell_m2 has a net current flowing in. During the “on” period (Tₒₙ) as illustrated in FIG. 15a, the switch is turned on, causing the inductor Lₘ₂ current to increase, and inductor Lₘ₁ currents decrease to zero and then increases. All diodes are off when Qₘ is turned on, as shown in FIG. 16b. During the “off” period (T_{off}) as illustrated in FIG. 15b, the switch is turned off, causing the current of the inductor Lₘ₂ to reduce, and the current of the inductor Lₘ₁ to reduce to zero and then increase. Only the diodes (e.g. Dₘ₂) corresponding to the battery cells that require charging are conducting, while the diodes associated with the higher voltage battery cells remain in the off state.

The whole battery string provides the input voltage for the single module. The input current of modules is equal to the current flowing out of the battery string. When the voltage of a cell is higher than the average voltage of the battery string, the diode in the AC/DC converter that is connected to the cell does not conduct, and the average current of inductor Lₘₖ (i_{o_mk}) is zero. This means that the average current flowing from the AC/DC converter to the cell is zero, and the discharging current of the battery cell is i_{Mm}. At the same time, the lowest voltage cell is charging. FIG. 16e shows the simplified circuit for each DC/AC circuit. According to equation (28), the input voltage of the circuit can be derived as

$$\frac{{v}_{module}}{n} = \frac{{\sum }_{k = 1}^{N} {V}_{Cell \_ mk}}{n} \qquad ( 39 )$$

Under steady-state condition, the maximum capacitor voltage stress is

$${V}_{Cap \_ max} = \frac{1}{2} {\sum }_{k = 1}^{N} {V}_{Cell \_ k} \qquad ( 40 )$$

Moreover, the voltage difference between the two capacitors in each cell circuit is equal to the battery voltage, shown as

$${V}_{C ( 2 k - 1 )} - {V}_{C 2 k} = {V}_{Cell \_ k} \qquad ( 41 )$$

Autonomous balancing means that the balancing current decreases as the voltage difference decreases. When the voltage differences between battery cells are eliminated, the equalization current also decreases to zero.

During the period in which the switch is turned on (Tₒₙ), as shown in FIG. 15a, the magnetizing inductance (L_{m,m}) is charged. The L_{m,m} voltage is

$${V}_{Lm , m} = {V}_{m o d u l e} \qquad ( 42 )$$

The inductor voltage can be expressed as

$$\{ \begin{matrix}{V}_{L m 1} = \frac{{\sum }_{k = 1}^{N} {V}_{Cell \_ mk}}{n} + {V}_{C m 1} - {V}_{C m 2} - {V}_{Cell \_ m 1} + {V}_{C m A} - {V}_{C m B} \\ {V}_{L m 2} = \frac{{\sum }_{k = 1}^{N} {V}_{Cell \_ mk}}{n} + {V}_{C m 3} - {V}_{C m 4} - {V}_{C e l {l}_{-} m 2} + {V}_{C m A} - {V}_{C m B} \\ ⋮ \\ {V}_{L m k} = \frac{{\sum }_{k = 1}^{N} {V}_{Cell \_ mk}}{n} + {V}_{C m ( 2 k - 1 )} - {V}_{C m 2 k} - {V}_{Cell \_ mk} + {V}_{C m A} - {V}_{C m B}\end{matrix} \qquad ( 43 )$$

All diodes are turned off, and the currents of the coupling capacitors are

$$\{ \begin{matrix}{i}_{C m 1} = - {i}_{L m 1} \\ {i}_{C m 3} = - {i}_{L m 2} \\ ⋮ \\ {i}_{C m ( 2 k - 1 )} = - {i}_{L m k}\end{matrix} \qquad ( 44 )$$

When the switch is turned off within T_{off}, the charging circuit and discharging circuit have different operating modes, as shown in FIG. 15b, in which Lₘ,m is being discharged. The voltage across Lₘ,m is

$${V}_{LM , m} = - n ( {V}_{C m 3} - {V}_{C m 4} + {V}_{C m A} - {V}_{C m B} ) = n ( - {V}_{C m 1} + {V}_{C m 2} + {V}_{Lm 1} + {V}_{Cell \_ m 1} + {V}_{CmA} - {V}_{CmB} ) \qquad ( 45 )$$

At this time, the diode Dₘ₂ in the circuit of the battery with the lowest voltage is turned on first. The voltage of the AC bus is clamped, and the other diodes (e.g. Dₘ₁) are turned off.

V_{Lm1} and V_{Lm2} can be expressed as

$${V}_{Lm 1} = - {V}_{Cell \_ m 1} + {V}_{C m 1} - {V}_{C m 2} + \frac{{V}_{Lm , m}}{n} + {V}_{C m 4} - {V}_{C m B} \qquad ( 46 )$$

$${V}_{L m 2} = - {V}_{Cell \_ m 2} \qquad ( 47 )$$

In addition, the relationships between capacitors' current are given by

$${i}_{C m 1} = - {i}_{L m 1} \qquad ( 48 )$$

$${i}_{C m 1} + {i}_{C m 3} + … + {i}_{C m ( 2 k - 1 )} = n {i}_{Lm , m} \qquad ( 49 )$$

Since the circuit operates at BCM, the period of time during which the inductance current remains constant can be neglected.

$$- ( \frac{{V}_{Cell 1}}{2 {L}_{2}} ( 1 - D ) {T}_{s} + {I}_{L 2\_ min} ) D + [ n ( \frac{{\sum }_{k = 1}^{N} {V}_{Cell \_ mk}}{2 {L}_{m}} D {T}_{s} + {I}_{Lm \_ min} ) + ( \frac{{\sum }_{k = 1}^{N} {V}_{Cell \_ mk}}{2 {nL}_{1}} ( 1 - D ) {T}_{s} + {I}_{L 1\_ min} ) ] ( 1 - D ) = 0 \qquad ( 50 )$$

Equation (50) illustrates the principle of capacitor amp-second balance of Cₘ₃, where D is the duty cycle of the switch, and I_{Lm1_min} and I_{Lm2_min} are minimum currents of inductors Lₘ₁ and Lₘ₂, respectively. According to KCL,

$${I}_{Lm 1\_ min} + {I}_{Lm 2\_ min} = - n {I}_{Lm , m \_ min} \qquad ( 51 )$$

During equalization, it is assumed that the current of a battery cells is a net outflow and the current of b battery cells is a net inflow. Equation (51) can be expressed as

$$a {I}_{Lm 1\_ min} + b {I}_{Lm 2 \_ min} = - n {I}_{Lm , m \_ min} . \qquad ( 52 )$$

By using (49), (50), and (52), the minimum current of L₂ can be derived as

$${I}_{Lm 2 \_ mn} = a \frac{{\sum }_{k = 1}^{N} {V}_{Cell \_ mk}}{2 n L} {( 1 - D )}^{2} {T}_{s} + \frac{n {\sum }_{k = 1}^{N} {V}_{Cell \_ mk}}{2 {L}_{m , n}} D ( 1 - D ) {T}_{s} - \frac{{V}_{Cell \_ m 2}}{2 L} D ( 1 - D ) {T}_{s} \qquad ( 53 )$$

where L=Lₘ₁=Lₘ₂. Similarly, according to capacitor Cₘ₁ amp-second balance, the minimum current of Lₘ₁ can be derived as

$${I}_{Lm 1 \_ min} = - \frac{{\sum }_{k = 1}^{N} {V}_{Cell \_ mk}}{2 n L} ( 1 - D ) {T}_{s} \qquad ( 54 )$$

The average current of the inductor L₂ is

$${I}_{L m 2} = \frac{{V}_{Cell \_ m 2}}{2 L} ( 1 - D ) {T}_{s} + {I}_{Lm 2\_ min} . \qquad ( 55 )$$

The average current of the magnetizing inductance L_{m,m} is the discharging current of the battery string during equalization, and it can be shown that

$${I}_{M m} = \frac{{D}^{2} {T}_{s} {\sum }_{k = 1}^{N} {V}_{Cell \_ mk}}{2} ( \frac{1}{{L}_{m , m}} + \frac{N}{{n}^{2} L} ) . \qquad ( 56 )$$

The equalization current can be calculated by (33), (55) and (56).

To demonstrate the effectiveness of the MAVE, a laboratory prototype of the IPOS-based equalization system based on those shown in FIGS. 13a and 13b is built and tested. Fig. The prototype contains two battery equalization modules. The equalization system supports 8 series connected battery cells which are grouped into two battery strings. Eight retired 2600 mAh Samsung ICR18650 lithium-ion battery cells are employed in experiment of the prototype. A balancing module can be expanded to accommodate up to 15 cells. The circuit parameters are summarized in Table II. A STM32F407 controller is used to control the MOSFET in the experiment. The coupled inductor turns ratio is 4.5:1. The number of cell circuits or the number of module layers can be adjusted according to the number of battery cells connected.

TABLE II
CRITICAL DESIGN PARAMETERS

| Component | Parameters | |
|---|---|---|
| MOSFET (Q [symbol] ) | BSC320N20N | |
| MCU | STM32F407 | |
| Diode (D [symbol] ) | 30BQ015 SCHOTTKY | |
| Battery | ICR18650 | |
| Coupled inductor turns ratio (n) | 4.5:1 | |
| Magnetizing inductance (L [symbol] ) | 220 | μH |
| Switching frequency (f [symbol] ) | 200 | kHz |
| Coupling capacitor | 13 | μF |
| (C [symbol] /C [symbol] /C [symbol] ) | | |
| Inductor (L [symbol] ) | 10 | μH |
| Filter inductor (L [symbol] ) | 4.7 | μH |

[symbol]

indicates data missing or illegible when filed

Furthermore, in order to enhance the conversion efficiency of the modular equalizer, low forward-voltage power Schottky diodes (30BQ015) are employed. The voltage data are recorded by a data logger (Keysight 34970 A).

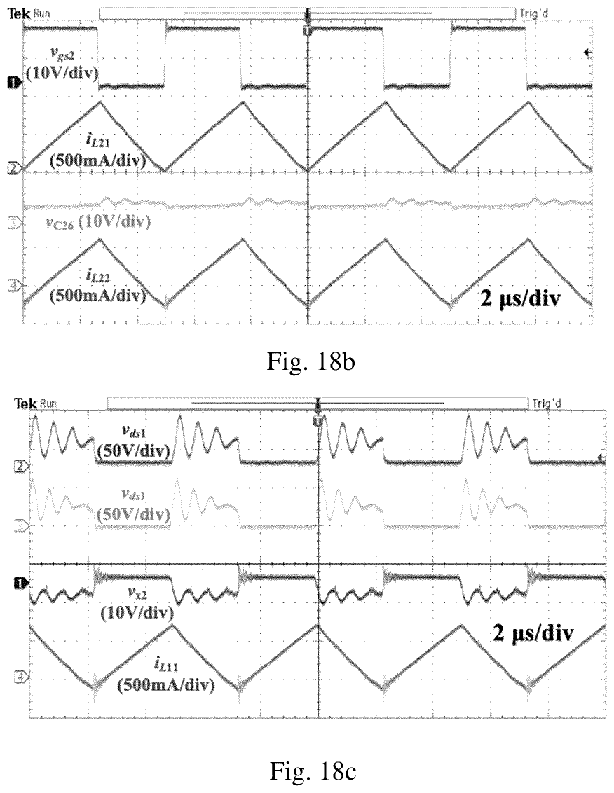

FIGS. 18a-18c show the key waveforms of module A, module B, and two layers structure, respectively. FIGS. 18a-18c show that the switching frequency is 200 kHz. As shown in FIGS. 18a and 18b, the inductors exhibit varying DC biases, due to variations in battery voltage. FIG. 18c illustrates the voltage across the MOSFETs of the two modules when a 2000 pF capacitor is connected in parallel. Soft switching can be achieved through the resonance of a parallel capacitor and the leakage inductance of a coupled inductor.

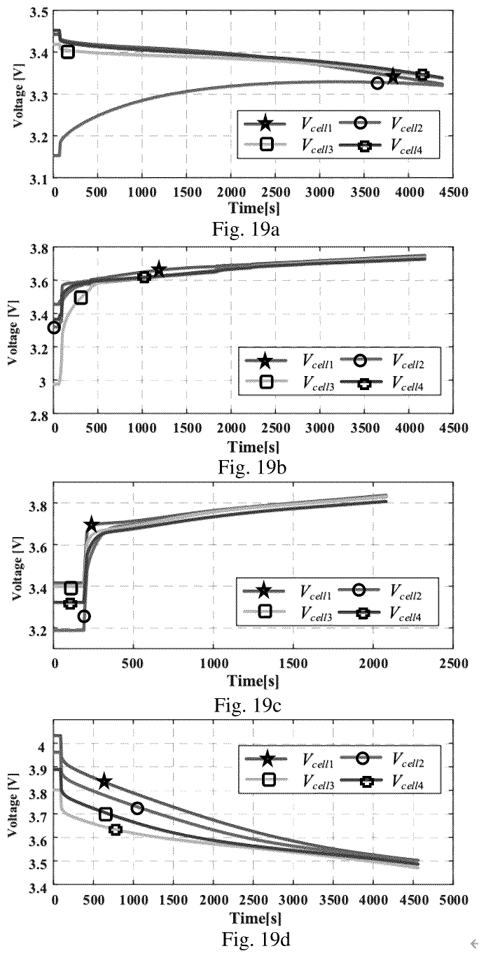

FIGS. 19a-19d depict the probed voltage of four battery cells in the experiment. These four battery cells are grouped as one battery string that is balanced by one equalizer module. FIG. 19a shows the equalization result under the static condition for four cells whose initial voltages are about 3.452, 3.442, 3.419, and 3.153V, respectively. The equalization circuit reduces the voltage difference from 299 mV to 18 mV in 4300 s. In FIGS. 19b and 19c, the balancing experiments are conducted with 1 A and 2 A charging current. The initial voltage differences are 479 mV and 229 mV. The voltage difference is lower than 20 mV after balancing. FIG. 19d shows the equalization result during the discharging process with a 16Ω load.

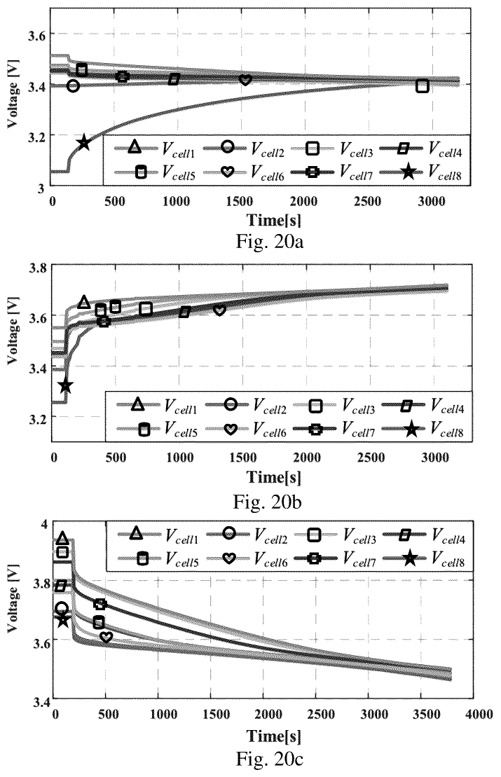

In order to further verify the performance of the modular equalizer, the multilevel balancing experimental results are captured in FIGS. 20a-20c. Two balancing circuits are coupled by the AC bus to balance eight series connected battery cells. Moreover, two modules share a controller, and a 200 kHz PWM signal drives two MOSFETs simultaneously. As shown in FIG. 20a, the modular equalizer reduces the voltage difference from 458 mV to 20 mV in 3060 s. In FIGS. 20b and 20c, the balancing experiments are conducted with 1 A charging current and a 320 load. The maximum voltage difference of the battery string is also lower than 20 mV and 30 mV after balancing, respectively.

To illustrate the merits of the MAVE mentioned above, a comprehensive comparison between the MAVE (labelled as “proposed method” in Table III) and the other similar equalizer is demonstrated in Table III. In [15], LCC resonant converter-based equalizer is proposed, which realizes constant current balancing with open-loop control. However, 2n relays are required as multiplexers. Numerous active switches lead to high control complexity and low reliability. In [16], the stacked buck-boost converter is proposed, which only needs a single switch for the battery string. However, the circuit cannot be modularized, as when the number of cells increases, the voltage stress on the switch increases significantly. The methods in [17], [18], and [19] can realize simultaneous balancing of multiple cells. Nevertheless, plenty of MOSFETs lead to low reliability and high cost. A multi-winding transformer is utilized in [20], which is however difficult to implement when the number of battery cells is large.

TABLE III
COMPARISON OF DIFFERENT EQUALIZERS

| | | | | | | | Transformers/ | |
|---|---|---|---|---|---|---|---|---|
| | | Switches | | | | | coupled | |
| | Modular | and | Sw | | | | inductors | Selection |
| Topologies | design | drivers | stress | diodes | capacitors | inductors | (windings) | switches |
| LCC[15] | No | 2 | nVcell | 2 | 2 | 1 | 1(3) | 2n |
| Stacked buck- | No | 1 | nVcell | n | n + 1 | n + 1 | 1(2) | 0 |
| boost [16] | | | | | | | | |
| AC-Bus | Yes | n/2 | 2Vcell | n | n | n | n/2 (n) | 0 |
| SEPIC [17] | | | | | | | | |
| Multiport | No | 4n + 4 | nVcell/ | 0 | 2n + 4 | n + 1 | 1(n + 1) | 2n |
| converter [18] | | | 2 | | | | | |
| Half-bridge | No | 2n + 4 | nVcell/ | 0 | 4 | 1 | 1(n + 1) | 0 |
| converter [19] | | | 2 | | | | | |
| Parallel- | No | 1 | nVcell | n + 1 | 1 | 0 | n/8(n + n/ | 0 |
| Transformers | | | | | | | 4 + 2) | |
| [20] | | | | | | | | |
| Proposed | Yes | m | nVcell/ | n | 2n + m | 2n + m | m(2m) | 0 |
| method | | | m | | | | | |

n is the battery cell number; m is the module number.

In summary, one can see that the MAVE can be designed modularly. In addition, for each module it only requires a single MOSFET, and no selection switch is required. When the number of battery cells increases, only the number of modules needs to be increased, and the voltage stress of the switch will not increase accordingly. The MAVE contains two stages in the system: a DC/AC converter which could be in the form of a voltage source, a current source, or a combination of voltage or current source; and a group of capacitively coupling AC/DC converters capable of autonomous energy distribution. Compared with conventional balancing circuits, the entire system does not require the selection switches to target specific balancing battery cells. Furthermore, using a single magnetic component in a module for the entire battery string reduces circuit size and weight significantly. What is more, each module contains only one semiconductor switching device, resulting in low costs and simplified control.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A battery equalizer for a series-connected battery string, comprising:
a plurality of cell circuits that are connected in parallel with each other at their input ends; each said cell circuit at its output end being adapted to connect to a corresponding battery cell of the battery string;
an AC link to which the plurality of cell circuits connects to at the input ends; and
a DC/AC converter connected to the AC link;
wherein each of the cell circuits comprises an AC/DC converter; an AC side of the AC/DC converter being capacitively-coupled to the AC link at the input end of the cell circuit.

2. The battery equalizer of claim 1, wherein the DC/AC converter comprises a voltage source, and an active switch which is connected between the voltage source and the AC link.

3. The battery equalizer of claim 2, wherein the active switch is the only active switch of the battery equalizer.

4. The battery equalizer of claim 2, wherein the DC/AC converter further comprises a first inductor as a magnetizing inductance, which is connected in series to the active switch between two ends of the voltage source.

5. The battery equalizer of claim 4, wherein the first inductor is the only magnetic component of the battery equalizer.

6. The battery equalizer of claim 2, wherein the voltage source is a first capacitor adapted to be charged by the battery string.

7. The battery equalizer of claim 1, wherein each said cell circuit further comprises two coupling capacitors at the input end; the AC/DC converter of the cell circuit connected to the AC link through the two coupling capacitors.

8. The battery equalizer of claim 1, wherein the AC/DC converter in each said cell circuit comprises, between two ends of the corresponding battery cell of the cell circuit, a second inductor and a diode which are connected in series.

9. The battery equalizer of claim 1, wherein each said cell circuit further comprises an output filter that is connected between the AC/DC converter and the corresponding battery cell of the cell circuit.

10. The battery equalizer of claim 8, wherein the output filter is a third inductor.

11. The battery equalizer of claim 1, wherein each of the AC/DC converters is a ZETA-derived converter.

12. The battery equalizer of claim 1, further comprises a transformer coupled between the DC/AC circuit and the AC link.

13. The battery equalizer of claim 2, wherein a duty cycle of the active switch is controlled based on a ratio between a string voltage of the battery string and a lowest cell voltage for each of the battery cells.

14. A battery system comprising a battery equalizer according to claim 1, and a series-connected battery string comprising a plurality of battery cells that are connected to the battery equalizer.

15. A method of conducting a battery equalization for a series-connected battery string, comprising steps of:
providing a first balancing current to a first battery cell in the battery string, the first balancing current based on an initial voltage difference between the first battery cell and remaining ones in the battery string; and
providing, to the first battery cell, a second balancing current which is gradually decreasing from the first balancing current; the second balancing current based on reduction of the voltage difference between the first battery cell and the remaining ones in the battery string;
wherein the second balancing current is further based on an AC voltage converted from a string voltage of the battery string.

16. The method of claim 15, wherein the AC voltage is obtained using an DC/AC converter coupled to the battery string; the DC/AC converter comprising an active switch and a first inductor connected to the active switch in series.

17. The method of claim 15, wherein the second balancing current is generated using a AC/DC converter that is coupled to the first battery cell; the AC/DC converter being capacitively coupled to an output of the DC/AC converter.
